(19) United States
(12) Patent Application Publication
(10) Pub. No.: US 2005/0259295 A1
(43) Pub. Date: Nov. 24, 2005

(54) Printing control device, printing control method, and printing control program product

(75) Inventor: Kenji Nagao, Nagano-Ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/110,954

(22) Filed: Apr. 21, 2005

(30) Foreign Application Priority Data
Apr. 30, 2004 (JP) 2004-135427

(51) Int. Cl. H04N 1/50; H04N 1/60; H04N 1/56; G06K 15/02

(52) U.S. Cl. 358/2.1; 358/518; 358/3.24; 399/28; 715/911; 358/523

(57) ABSTRACT

In the course of controlling a printing device that executes printing utilizing a plurality of recording materials in a relationship whereby output color of a particular recording material is substitutable by output color of another recording material, print data that indicates an image targeted for printing is acquired, a usage quantity for each recording material is determined on the basis of the print data, it is detected whether the remaining quantity of the particular recording material is less than a predetermined baseline, an attribute of the image is detected on the basis of the print data, when it is detected that the remaining quantity of a particular recording material is less than a predetermined baseline, a portion of the particular recording material is substituted with the aforementioned other recording material so that substitution level differs for each attribute of images targeted for printing, the determined usage quantity is corrected, and printing is executed with the usage quantities derived thereby.

### BACKGROUND OF THE INVENTION

1. Field of the Invention

The present invention relates to a printing control device, a printing control method, and a printing control program product.

2. Description of the Related Art

Most printers use toner or ink of several colors to form images on printing media, and typically if the recording material for even a single color is used up, printing is no longer possible. Accordingly, there has been proposed technology for extending the period of time until recording materials for certain colors run out (see Japanese Patent Application Laid Open 9-265223, for example).

### SUMMARY OF THE INVENTION

With the technology mentioned above, it is simply the case that the time until the recording material runs out is extended, and it was not possible to continue printing while maintaining high picture quality. That is, according to Patent Citation 1 above, remaining quantity of each color toner is detected, and when remaining quantity falls below a predetermined value the UCR level with black toner is controlled; however, effect on image quality is not taken into consideration at this time. More specifically, there are a number of factors black toner that affect picture quality, such as whether an optimal quantity of recording material is used for attributes of an image, whether there is correct balance of the quantity of each color used (e.g. black and chromatic colors), and whether color matching has been done with high accuracy. However, these factors are not taken into consideration in the technology to date.

With the foregoing in view, it is an object of the present invention to provide a printing control device, a printing control method, and a printing control program product whereby it is possible to extend the time until the recording material runs out, while nevertheless maintaining high picture quality.

To achieve at least one of the stated objects, according to the present invention, when determining the quantity of a recording material to be used on the basis of print data, the baseline usage quantity is corrected with reference to the remaining quantity of the recording material and to image attributes. Specifically, where the remaining quantity of a particular recording material is lower than the baseline, the usage quantity is corrected such that the rate of decrease of the particular recording material is slower than it would be where printing is carried out at the baseline usage quantity. Usage quantity is corrected by a different correction level for each attribute, by means of detecting image attributes. As a result, it is possible to correct usage quantity so that the time until the recording material runs out is extended, while at the same time maintaining picture quality to the greatest extent possible for the image attributes.

The degree of effect on picture quality produced by correction of usage quantity of recording material differs depending on the image attributes. For example, where an image consists of text, while crisp black printing is considered to contribute to high picture quality, there are also cases in which the effects of a certain extent of color difference of text may be considered to have negligible effect on picture quality. For non-text images, e.g. graphs or other graphic images as well, the important thing is the information per se that is read from the graph, and thus a certain extent of color difference is permissible; however, for non-text images that are photographic images, faithful reproduction to color is desirable.

That is, the permissible level of correction of baseline usage quantity (usage quantity determined by a usage quantity determining portion) differs depending on image attributes, and the permissible level therefor can be determined on the basis of various indicators. However, in any event, by employing an arrangement whereby usage quantity is corrected depending on attribute rather than using a uniform correction level for each image attribute, it becomes possible to control in the desired manner the effects on picture quality produced by correction of usage quantity for a desired attribute. Accordingly, the usage quantity balance of black and chromatic color recording material can be corrected as appropriately as possible for each attribute, and control can be carried out so as to provide as highly accurate color matching as possible for each attribute.

In the printing device, it is sufficient to be able to print using recording materials that can be interchanged for one another. Here, recording materials may be any materials able to output various colors by being recorded onto a printing medium, it being possible to use various materials such as toners or liquid inks. Also, in instances where similar apparent color can be produced when the aforementioned particular recording material or another recording material is recorded on a printing medium, the particular recording material and the other recording material are considered to be substitutable.

For example, in some instances a combination of recording materials of several hues, recorded in a very small location, can appear as a different color to the human eye. Accordingly, when color represented by a combination of recording materials of several hues is similar to output color of a given recording material, there may be employed an arrangement whereby these several recording materials is designated as the aforementioned other recording material; or conversely to employ an arrangement whereby the aforementioned given recording material is designated as the aforementioned other recording material. For example, K (black) can be represented by a combination of the three colors CMY (cyan, magenta, yellow). Accordingly, the three colors CMY may be designated as particular recording materials substitutable with K as the other recording material, and K may be designated as particular recording material substitutable with the three colors CMY as the other recording materials. Of course, it would also be possible to employ various other arrangements, such as an arrangement in which R (red) is substitutable with M and Y.

For light/dark recording materials that, depending inter alia on the quantity of color material contained in the recording material per unit of weight, produce generally the same hue but different densities when a unit quantity of recording material is recorded onto a printing medium, one of the materials may be designated as the given recording material and the other as the other recording material. Specifically, such light/dark recording materials are substitutable by means of correcting recording quantity, e.g. where inks are recorded on the printing medium in a ratio of 2 parts light recording material to 1 part dark recording material produce substantially identical apparent color. Accordingly, where the dark recording material is designated as the particular recording material, the light recording material can be designated as the other substitutable recording material; conversely, where the light recording material is designated as the particular recording material, the dark recording material can be designated as the other substitutable recording material.

The print data which is acquired by the print data acquiring portion need simply contain an image targeted for printing, any may employ any of various arrangements. For example, it may consist of data describing an image targeted for printing together with printing conditions in page-description language, or data specifying tones of each color component for pixels in a dot matrix making up an image. In the usage quantity determining portion, it suffices to determine usage quantities of recording materials when the image represented by the data is output by a printing device. For example, it would be possible to employ an arrangement wherein usage quantities are determined on a recording material color-by-color basis for each pixel of the dot matrix making up the image.

Of course, where the usage quantities of recording materials when forming an image with print data are specified directly, usage quantities may be determined per the specification; or where specified indirectly, subjected to predetermined conversion to acquire data specifying usage quantities. For example, with an arrangement wherein recording material usage quantities are expressed as tone values, with recording material usage quantities being specified in a color system having the colors of the recording materials as its color components, where image data of a different color system (e.g. the RGB color system or L*a*b* color system) is used in the print data, usage quantities may be determined by means of a color conversion process using a predetermined profile.

As the profile, it would be possible to employ a LUT that specifies correspondence relationships for a plurality of reference points in each of the different color systems, or a profile in which correspondence relationships among different color systems are specified by a function. In either case, recording material usage quantities determined by the usage quantity determining portion are the baseline usage quantities in the printing device. That is, the usage quantities are usage quantities for the purpose of carrying out printing in a state in which all of the recording material remaining quantities exceed baseline, and the process pertaining to the invention is not executed. Accordingly, by carrying out printing with these usage quantities, the image targeted for printing is printed in a condition of highly accurate color matching.

In the usage quantity determining portion, while it is sufficient to determine usage quantity of each recording material, it is possible here as well that usage quantity will differ depending on image attributes. For example, where determinations to record or not record recording material are made using halftone algorithms that differ depending on image attributes, even if the same tone values are specified in the color system employed with the print data, recording/non-recording of recording material will differ depending on image attributes. Accordingly, for recording material it is possible to designate different usage quantities depending on image attributes.

In the recording material remaining quantity detecting portion, it suffices to be able at a minimum to detect the remaining quantity of particular recording material substitutable with another recording material, with various arrangements being possible for doing so. For example, there may be provided a sensor that physically detects the remaining quantity of ink or toner contained in a cartridge; or the amount of toner or ink used after the cartridge has been replaced may be calculated or estimated and subtracted from the initial quantity, to arrive at the remaining quantity. Of course, recording material usage quantities may be detected sequentially, but it suffices to be able at a minimum to detect whether remaining quantity is less than a predetermined baseline.

In the attribute detecting portion, it suffices to be able to detect relevant attributes from print data, and to classify images in advance according to desired characteristics and detect to which class an image belongs. Various processes are possible for use as processes for detecting attributes; for print data described in page-description language, they may be detected from the description, or for data specifying tones of each color component for pixels in a dot matrix making up an image, they may be detected by analysis of the data.

For example, in the former instance, it can be detected from the commands thereof whether a font is formed, whether a bitmap image is used, or whether a predetermined graphic is drawn, making it possible to detect image attributes on the basis of these commands. In the latter instance, on the basis of tone it can be detected whether a given color is continuous within an image, or whether any characteristic regions such as right angles are present. When it is considered that continuous given color is characteristic of graphics and text, while characteristic regions are characteristic of graphics, it is possible to detect the attributes of an image from tones. Of course, attributes can be distinguished by means of various other conditions as well. For example, there could be employed an arrangement wherein attributes are classified by means of the spatial frequency spectrum of an image, calculating the spatial frequency spectrum of the image from the print data to determine the attributes.

In preferred practice, once attributes of an image have been detected by the attribute detecting portion, identifying data for identifying the attributes will be associated with the image. By means of this arrangement, it is possible to ascertain readily the nature of image attributes when performing correction by means of the usage quantity correcting portion. While it is sufficient for identifying data to enable image attributes to be ascertained accurately, in the usage quantity correcting portion, it is necessary to ascertain attributes after usage quantities have been determined in the usage quantity determining portion. Accordingly, it would be acceptable to adopt an arrangement whereby, once recording material usage quantities have been determined on a pixel-by-pixel basis, identifying data that indicates attributes thereof is associated with each pixel.

In the usage quantity correcting portion, it is sufficient to be able to correct usage quantities determined by the usage quantity determining portion for recording material whose remaining quantity is less than baseline; at this time, substitution is carried out at substitution levels that differ by image attribute. Specifically, by carrying out substitution between the aforementioned particular recording material and other recording material according to a given rule, the combination of recording materials used can be modified while generally preserving output color. Further, at this time since substitution levels differ by image attribute, an appropriate substitution level for each attribute may be designated readily even in instances where appropriate substitution level differs depending on image attributes. Here, it suffices to be able to carry out correction of usage quantity by substituting a particular recording material with a substitutable recording material, and it is possible to employ various rules as the specific substitution rule. Specifically, provided that at a minimum substitution level differs by attribute, appropriate substitution levels can be readily arrived at for each attribute.

In the printing portion, it is sufficient to record the recording materials at the obtained usage quantities, i.e. the usage quantities determined by the usage quantity determining portion; or where usage quantities have been corrected by the usage quantity correcting portion, at the corrected usage quantities. For example, it would be acceptable to employ an arrangement for creating data for driving the parts of the printing device so as to print at the obtained usage quantities, and supplying this data to the printing device. As a result, in the printing device, it becomes possible to extend the time until the recording material is used up, while maintaining high picture quality to the greatest extent possible.

As an example of an appropriate arrangement in the aforementioned attribute detecting portion, there could be employed an arrangement wherein, at a minimum, text and non-text images are assigned different attributes. As a result, the efficiency of substituting recording materials will differ between text and non-text images, and it will become possible to carry out printing under different conditions of color matching accuracy, recording material usage quantity balance, and so on. For example, where color matching accuracy for text must be maintained whereas lower color matching accuracy is permissible for non-text, an arrangement whereby substitution levels are made smaller for text than for non-text could be employed. Of course, where color matching accuracy for non-text must be maintained whereas lower color matching accuracy is permissible for text, an arrangement whereby substitution levels are made smaller for non-text than for text could be employed.

Additionally, comparing text and non-text images (drawings, pictures, photographs etc.), whereas in the case of text it is almost certain that there will be areas of the printing medium devoid of recording material recorded thereon so that the surface is exposed, in the case of non-text on the other hand, there are instances in which substantially none of the printing medium surface is exposed, with recording material usage quantities tending to be higher in general. Accordingly, by employing an arrangement whereby substitution levels are larger for non-text than for text, substitution can be carried out very efficiently, and the time until recording material is used up can be effectively extended.

As an arrangement whereby substitution levels are smaller for non-text images than for text, there could be employed an arrangement such as one where, designating the substitution level of the aforementioned particular recording material when the attribute is text as X, and designating the substitution level of the aforementioned particular recording material when the attribute is non-text as Y, a relationship is defined such that 0≦X<Y. That is, effects similar to the effects described earlier can be obtained even with an arrangement wherein substitution is not performed for text (i.e. no correction). Of course, it is sufficient for X and Y to designate recording material quantities; there is no particular limitation as to units. For example, tone value differential, recording rate differential, or the like could be employed.

While non-text images need not be text, for text other than text such that the printing medium surface is exposed to the outside of the outlines of the text (i.e. text specified by so-called font data), the attribute can be classified as non-text. An example of such text is a designed logo mark, for example. As noted, non-text images can include drawings, pictures, photographs and so on. Of course, it is also possible to modify substitution levels by assigning different attributes to drawings, pictures, and photographs.

It is also possible to determine appropriate substitution levels on a per-attribute basis, based on various viewpoints. For example, it is possible to designate different substitution levels depending on the required color output accuracy. That is, for a printing target requiring printing with a given color, such as a company logo mark, highly accurate color matching is required. Where recording material usage quantity correction is carried out in the present invention, color output accuracy can decline as compared to printing with baseline usage quantities.

Given this, by making the substitution level smaller in association with higher required levels of color output accuracy, printing can be carried out without excessive drop in color output accuracy. Of course, there could also be employed an arrangement whereby recording material substitution is not performed for targets requiring highly accurate output. In such an arrangement, it is sufficient to be able to determine required color output accuracy for each image to be printed with print data, it being possible to employ an arrangement such as one specifying output accuracy on a per-image basis and whether substitution level determination should be carried out, depending on output accuracy.

Substitution level may also differ depending on recording material usage quantity determined by the aforementioned usage quantity determining portion. That is, since the extent to which the effects of recording material substitution are noticeable varies depending on the usage quantity of recording material, different substitution levels are assigned depending on recording material usage quantities determined by the usage quantity determining portion. For example, substitution level can be larger for colors for which the effects of substitution are not very noticeable, and smaller for colors for which the effects of substitution tend to be noticeable. As a result, the time until recording material is used up can be effectively extended, while suppressing the effects of substitution to the greatest extent possible.

Here, as effects resulting from substitution, there can be cited by way of example effects on hue and saturation of color and on grainy appearance, at the aforementioned determined recording material usage quantities. For example, with colors that have low recording material usage quantities, hue and saturation variations tend to be quite noticeable at even low substitution levels, as compared to colors that have larger recording material usage quantities. In the aforementioned usage quantity determining portion, it is typical to determine usage quantity in such as way as to minimize graininess, whereas correction of usage quantity through substitution tends to make graininess more apparent. Given this, where substitution levels are reduced for colors that have low recording material usage quantities, the effects of substitution can be minimized.

In the manner described above, the present invention can extend the time until the recording material runs out while nevertheless maintaining high picture quality, by using recording material in appropriate quantities for different attributes by means of performing substitution at different levels for different attributes of images targeted for printing, with respect to the recording material baseline usage quantities, when the remaining quantity of a particular recording material is less than the remaining quantity of the aforementioned other recording material. Additionally, usage quantity balance of each color of recording material can be maintained appropriately, and correction of usage quantity can be carried out while performing color matching with high accuracy. Of course, here, baseline usage quantities may be usage quantities of recording materials determined so as to carry out color matching without any consideration given to extending the time until the recording material runs out.

The concept of the invention encompasses various modes, such as instances where the aforementioned printing control device is reduced to practice independently, or reduced to practice together with another method, in a form incorporated into a given devices, and so on; and as such may be modified appropriately. Whereas the method for correcting recording material usage quantity with different substitution levels for different image attributes involves a process that proceeds according to a predetermined procedure, at the foundation thereof an invention resides in the procedure by necessity. Accordingly, the invention may be embodied as a method. When reducing the invention to practice, the printing control device may in some instances execute a predetermined program. The present invention may also be embodied as such a program product.

Of course, it is possible to make an arrangement embodied in a device correspond to the aforementioned method or program product. It is possible to use any sort of storage medium for providing the program product For example, electromagnetic storage media or magnetooptical storage media would be acceptable, and any storage medium that may be developed in the future may be viewed in exactly the same way. Even where portions are realized by hardware and other portions by software, the concept of the invention is in no way different, and modes in which portions are recorded onto a recording medium and read out appropriately as needed are encompassed herein. Further, replication stages, e.g. primary replication, secondary replication and so on, are equivalent without exception.

### BRIEF DESCRIPTION OF THE DRAWINGS

FIG. 1 is a simplified illustration depicting the printing control process.

FIG. 2 is a block diagram of the printing control device.

FIG. 3 is a flowchart of the printing control process.

FIG. 4 is an illustration of the specifics of color correction.

FIG. 5 is an illustration of the specifics of color correction.

FIG. 6 is a diagram showing substitution for chromatic colors.

### DETAILED DESCRIPTION

The embodiments of the invention will now be described, in the order indicated below.

(1) Overview of Printing Control Process:

(2) Arrangement of Printing Control Device

(3) Specifics of Printing Control Process:

(4) Other Embodiments:

(1) Overview of Printing Control Process:

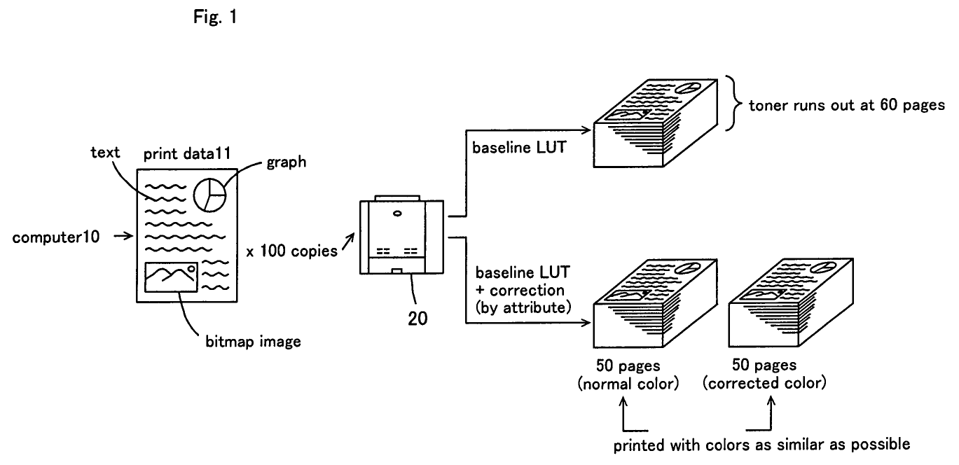

FIG. 1 is a simplified illustration depicting the printing control process. In this embodiment, print data 11 created by a computer 10 is transferred to a printer 20, whereupon the print data is analyzed and printed by the printer 20. The print data 11 in this embodiment specifies in predetermined page-description language an image targeted for printing; images classified according to various attributes can be described by the page-description language. In the page-description language there can also be specified various printing parameters such as the printing resolution, the printing medium used, the LUT used, the number of copies being printed, and so on. In the example depicted in FIG. 1, text, a graph, and a bitmap image are specified as the printing target by the print data 11, it being specified that 100 copies of the printing target be printed.

The printer 20 receives the print data 11, and by means of analyzing its language renders the image shown in FIG. 1, as well as setting the aforementioned printing parameters such as printing resolution and number of copies being printed, before commencing printing. Typically, the color system used to identify colors of an image in the print data 11 differs from the color system having as its components the colors of the recording materials used by the printer (toner in the case of this embodiment). Accordingly, reference is made to a LUT (lookup table) to convert the color system of image rendered on the basis of the print data 11 into the color system having as its components the colors of the recording materials.

The printer 20 of this embodiment has installed therein a cartridge filled with toner of the colors CMYK. After the print data 11 has been analyzed in the printer 20, there is created image data that provides tone representation of color of each pixel in a dot matrix array. Accordingly, with color conversion in the LUT, tone values of the image composed of pixels in a dot matrix array are converted to tone values of each of the colors CMYK. Usage quantities of toner of the colors CMYK are determined as a result.

The aforementioned LUT specifies correspondence relationships between color in two different color systems for a plurality of reference points, and is created such that colors of the image specified by the print data 11 are reproduced by a combination of CMYK toner. That is, color matching is performed. Herein, this LUT is designated as the baseline LUT, and usage quantities of toner of the colors CMYK determined with reference to this LUT are designated as baseline usage quantities.

Once usage quantities of toner of the colors CMYK have been determined, the toner is recorded onto the printing medium by means of the print engine of the printer 20, and an image like that shown at left in FIG. 1 is formed on the printing medium. Since the print data 11 specifies that printing should be carried out on 100 pages of the printing medium, the printer 20 continuously supplies sheets of the printing medium from the printing medium tray, and carries out printing. In FIG. 1, there is shown an example in which toner of any color has run out at the 60 page mark, where printing has been carried out at baseline usage quantities.

When toner of any color runs out in this way, printing is suspended despite the fact that not all of the pages specified by the print data 11 have been printed; according to the present invention, however, by means of carrying out printing with corrected toner usage quantities, printing can be completed without suspending printing. In the present invention, correction is carried out at different correction levels for different image attributes, so a favorable correction level can be used for each attribute. That is, whereas for the same given value in the color system of the print data 11 the optimal baseline usage quantity can differ by attribute, so if the same correction level is used for all attributes, it is easy for there to arise a condition in which correction can be carried out while reducing color variation for a given attribute, but with appreciable color variation for other attributes.

Given this, by using different correction levels for different attributes, optimal correction levels may be achieved for all attributes, without appreciable color variation from output color at baseline usage quantities. As a result, control can be exercised in such a way that normal color printed at baseline usage quantities and corrected color printed at corrected usage quantities can be colors that approximate one another as closely as possible. Also, in order to reduce graininess and carry out printing at optimal hue and saturation, the balance of toner of the colors CMYK is corrected at the aforementioned baseline usage quantities. Accordingly, if this balance is modified by means of correction in the present invention, graininess may be produced or deviation in hue or saturation may occur. However, since it is possible to vary correction level on a per-attribute basis, corrections can be made while avoiding excessive correction for individual attributes. As a result, the time until toner is depleted can be extended, while maintaining picture quality at the highest possible level.

(2) Arrangement of Printing Control Device

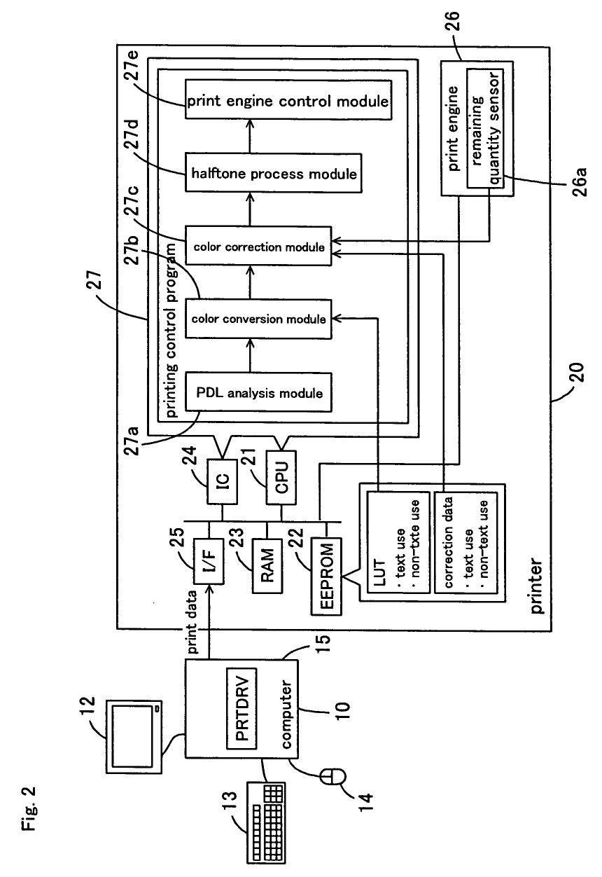

The arrangement of the device for carrying out the preceding printing control process will now be described. FIG. 2 shows the hardware arrangement of the printer 20 and a functional block diagram of a printing control program executed in the printer 20 for carrying out printing control. In FIG. 2, the computer 10 is a general-purpose personal computer to which are connected a display 12 and input devices such as a keyboard 13 and a mouse 14. By manipulating the input devices while viewing images displayed on the display 12, the use can create an image targeted for printing, and issue a print command.

In the computer 10, a printer driver (PRTDRV) 15 is executable under the control of the OS. When the aforementioned print command is issued, the PRTDRV 15 creates print data 11 that describes the type of printing medium, the model of the printer 20, the resolution, number of pages for printing, and other printing conditions, as well as the content of the image and fonts, and sends this information to the printer 20 through a communication line.

The printer 20 comprises a CPU 21, EEPROM 22, RAM 23, an IC 24, and an I/F 25, these being interconnected via a bus. In the CPU 21, EEPROM 22, RAM 23, and the IC 24, it is possible to execute a program recorded into EEPROM 22 or ROM (not shown); in the IC 24, it is possible to execute predetermined data processing, e.g. a color conversion process or halftone process. For example, the I/F 25 is connectable via a communication line to the I/F (not shown) of the computer 10, whereby the print data 11 output by the computer 10 can be acquired under the control of a predetermined program.

The printing control program 27 depicted in FIG. 2 is executed, and printing is executed by means of carrying out a process based on this print data 11. Specifically, the print engine 26 comprises mechanisms for carrying out laser exposure/scanning and paper feed, and on the basis of the data produced by the printing control program 27, controls the driving of the laser exposure/scanning and paper feed mechanisms to carry out printing. The print engine 26 also comprises a remaining quantity sensor for detecting remaining quantities of each color toner; the printing control program 27 can acquire the detection results and carry out a predetermined process.

The printing control program 27 comprises a PDL analysis module 27a, a color conversion module 27b, a color correction module 27c, a halftone process module 27d, and a print engine control module 27e. The print data 11 received via the aforementioned I/F 25 is handed over to the PDL analysis module 27a, which interprets the PDL. Specifically, the print data 11 includes information indicating printing resolution, type of printer paper, and the LUT for reference, as well as an image description command; the PDL analysis module 27a analyses the information and image description command, and creates raster data for the purpose of forming an image targeted for printing onto the printing medium.

The PDL analysis module 27a can discern among attributes of images targeted for printing. In this embodiment, text images and non-text images are classified as different attributes; in the event that rendering of text is specified by the aforementioned image description command, the image is discerned as being text, whereas in the event that rendering of text is not specified, for example, the graph or bitmap image rendered on the basis of vector data is discerned as being a non-text image. To the raster data for each type of image is appended identifying data that indicates the discernment result, so that the discerned contents can be identified.

The aforementioned raster data is data that identifies color of pixels by means of identifying tone values of predetermined color components, for each pixel in a dot matrix array; as the color system, a user-preferred color system (e.g. RGB, L*a*b*, or CMYL color system) may be selected. Regardless of the color system selected, the color system will constitute the color system used when creating on the computer 10 an image targeted for printing, and is typically different from the color system of the image data that directly specifies toner usage quantities in the printer 20.

Given this, with the printing control program 27, the color system is converted to acquire raster data that represents colors of pixels in the color system whose color components are the toner colors. The color conversion module 27b is the module responsible for color conversion; it accesses EEPROM 22 and refers to the LUT identified by analysis by the aforementioned PDL analysis module 27a. In this embodiment, a LUT is prepared for each image attribute; the PDL analysis module 27a discerns the attribute of each item of raster data on the basis of the identifying data appended to it, and the color conversion module 27b refers to the appropriate LUT for each attribute.

Specifically, since the halftone algorithm to be applied by the halftone process module 27d differs between text and non-text, and the LUTs are created such that color matching will be performed on the premise of processing by these different algorithms, the LUTs created as a result will naturally differ as well. Meanwhile, by having a different LUT for each attribute, appropriate toner usage quantities can be determined on a per-attribute basis, making it possible to carry out printing while applying an appropriate halftone algorithm for each attribute.

Under conditions in which sufficient toner remaining quantity is assured, the raster data having been converted by the color conversion module 27b is then handed over to the halftone process module 27d; however, in the event that toner remaining quantity has dropped below a predetermined value, in order to extend to the greatest extent the time until the toner is depleted, the color correction module 27c performs a correction process. Specifically, the color correction module 27c detects the color toner whose remaining quantity has dropped below the predetermined value, and once detected, performs correction so as to reduce the usage quantity of the low toner to a level below the baseline usage quantity, while increasing the other color toners to above their baseline usage quantities.

Detection of toner remaining quantity is carried out on the basis of the output signal of the remaining quantity sensor 26a of the print engine 26. Specifically, the remaining quantity sensor 26a can detect the remaining quantity of toner for each color, and output a signal indicating the remaining quantity. The color correction module 27c ascertains toner remaining quantity from this output signal, and compares the toner remaining quantity with a predetermined threshold value to detect whether toner remaining quantity has fallen below a predetermined value.

Color-converted raster data is corrected by means of referring to the correction data recorded in EEPROM 22. Correction data is data indicating correction level determined in advance for raster data tone values; raster data tone values are incremented or decremented by the correction level. Correction data is prepared on a per-attribute basis; here, correction is carried out with reference to correction data suitable for each image attribute. The details of the process will be described later.

The halftone process module 27d carries out halftone processing on halftone data after conversion by the color conversion module 27b or after correction by the color correction module 27c. Specifically, halftone data representing color of the image represented by the aforementioned raster data (typically in 256 tones for each color) is created with the tone number representable in each pixel by the printer 20. During this halftone process, it is possible to employ various algorithms; in this embodiment, however, processing is carried out with different algorithms depending on whether it is a text image or non-text image.

Specifically, attributes are discerned on the basis of the aforementioned identifying data, and halftone processing is carried out with a particular algorithm determined in advance for each attribute. The print engine control module 27e is a module that controls the print engine 26 so as to record toner on a pixel-by-pixel basis on the basis of the halftone data; it creates data for control purposes, and outputs it to the print engine 26. As a result, the image described in the print data 11 is formed on the printing medium.

(3) Specifics of Printing Control Process:

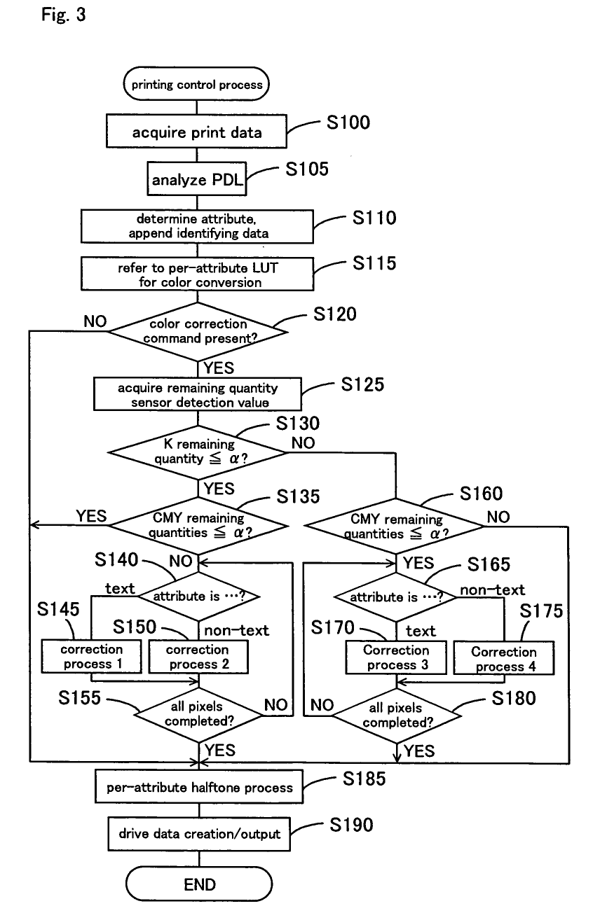

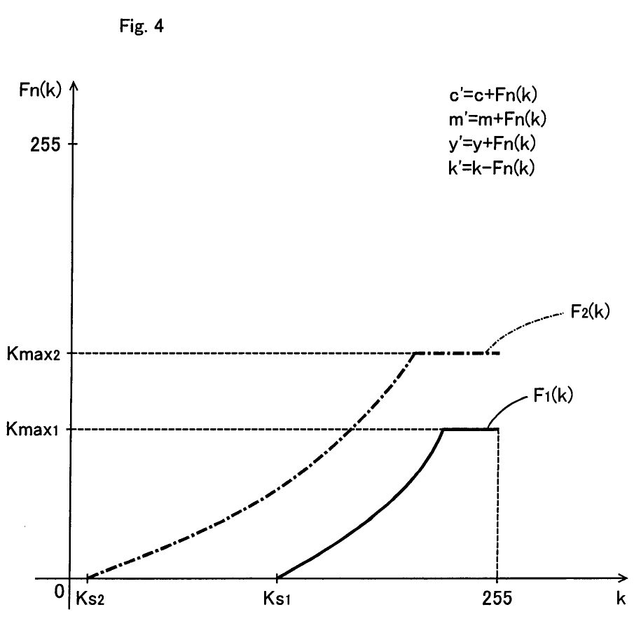

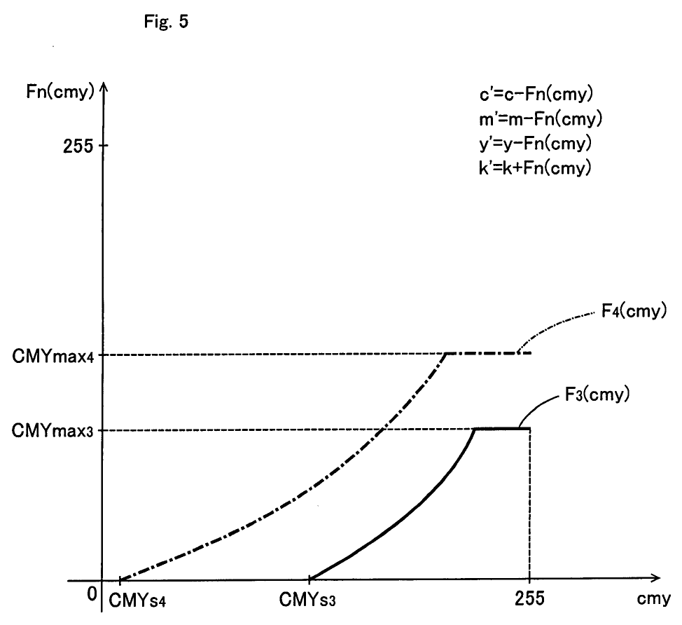

Next, the processes in the aforementioned printing control program will be described in detail. FIG. 3 is flowchart of this printing control process; FIGS. 4 and 5 are illustrations of the specifics of color correction. In the printer 20, at the outset of the printing control process, the user creates on the computer 10 an image targeted for printing, and issues a print command. At this time, it can be specified whether or not to execute the color correction process pertaining to the invention in the event that the remaining quantity of toner has decreased. In any case, once the print command is issued, the print data 11 is output from the computer 10 and received by the printer 20 (Step S100). In the event that execution of the color correction process is specified, data to that effect is embedded in the print data 11.

The PDL analysis module 27a analyzes the page description language described in the print data 11 (Step S105) to ascertain various printing parameters. On the basis of each command, an image targeted for printing is rendered, and raster data is created. At this time, the PDL analysis module 27a determines whether each image based on the print data 11 is a text image or a non-text image, and appends to the raster data identifying information that identifies the result (Step S110). In this identifying data, it is sufficient to be able to indicate, for each pixel image, whether it is text or non-text; it is possible to accomplish this in various forms, such as associating a flag with each pixel.

Next, the color conversion module 27b ascertains on the basis of the identifying data whether each pixel image is text or non-text, and if it is text, making reference to the text LUT recorded in EEPROM 22, performs color conversion of the aforementioned raster data. In the case of non-text, it makes reference to the non-text LUT recorded in EEPROM 22, and performs color conversion of the aforementioned raster data (Step S115). In this raster data, tone values of color components are specified on a pixel-by-pixel basis, these tone values corresponding to toner usage quantities.

Next, the color correction module 27c determines whether there has been an instruction to execute the color correction process pertaining to the invention (Step S120), and in the event of a determination that there has been no instruction to execute the color correction process, skips Step S125-Step S180. When in Step S120 it is determined that there has been an instruction to execute the color correction process, the color correction module 27c acquires the output signal of the remaining quantity sensor 26a, and acquires the detection value in the remaining quantity sensor 26a (Step S125).

It then determines whether the remaining quantity of K toner is below a threshold value α (Step S130). When it is determined in Step S130 that the remaining quantity of K toner is below the threshold value α, a further determination is made as to whether remaining quantity of any of the CMY toners is below the threshold value α as well (Step S135). When it is determined in Step S135 that remaining quantity of any of the CMY toners is below the threshold value α, it will be the case that remaining quantities of both the black toner and at least one color among the CMY toners are low. In such a case, even if correction were carried out so as to substitute toners according to the substitution rule in this embodiment, it would still not be possible to extend the time until toner runs out, so the correction process is skipped.

When it is determined in Step S135 that none of the remaining quantities of CMY toner are below the threshold value α, since there is some extra remaining quantity of CMY toner, a process for substituting CMY toner for K tone is performed. In the present invention, since correction is carried out appropriately for different attributes by designating different substitution levels for different image attributes, the color correction module 27c determines the attribute of the image on the basis of the aforementioned identifying data (Step S140). In the event it is determined in Step S140 that the image attribute is text, text correction (correction process 1) is performed (Step S145). If it is determined in Step S140 that the image attribute is non-text, non-text correction (correction process 2) is performed (Step S150).

In FIG. 4, specific examples of correction data in correction processes 1 and 2 are shown in graph form. Here, the horizontal axis indicates tone value k of the K component in uncorrected raster data, and the vertical axis indicates substitution level Fₙ(k). n is a natural number, with n=1 indicating the correction level of correction process 1 and n=2 indicating the correction level of correction process 2. Where tone values of the CMY components are designated respectively as cmy, and corrected CMYK tone values are designated respectively as c′, m′, y′, and k′, corrected tone values are given by the following equations.
c′=c+Fₙ(k)
m′=m+Fₙ(k)
y′=y+Fₙ(k)
k′=k+Fₙ(k)

In correction processes 1 and 2, correction level calculations are made on the basis of the aforementioned equations; however, by varying the form of the function between F₁(k) and F₂(k) as shown in FIG. 4, different substitution levels are produced in correction processes 1 and 2. Specifically, for both F₁(k) and F₂(k), when the tone value k is gradually increased, Fₙ(k) increases gradually once tone value k exceeds a predetermined value (Kₛ₁, Kₛ₂), and once tone value k exceeds a certain tone value, Fₙ(k) maintains a constant value (Kₘₐₓ₁, Kₘₐₓ₂).

As shown in FIG. 4, Kₛ₁>Kₛ₂ and Kₘₐₓ₁<Kₘₐₓ₂; the rate of increase in F₁(k) and F₂(k) is about the same. Accordingly, between the substitution level F₁(k) of correction process 1 and the substitution level F₂(k) of correction process 2, the substitution level F₁(k) of correction process 1 is smaller. That is, substitution level is smaller for text images than for non-text images.

As described hereinabove, correction is carried out by means of adding or subtracting the substitution level Fₙ(k) from the original tone values cmyk, at which time substitution level Fₙ(k) is subtracted from the k toner, while adding substitution level Fₙ(k) to the cmy toner. Accordingly, substitution is carried at a 1-to-1 ratio of K toner quantity to CMY toner quantity. That is, substitution is carried out on the basis of the fact that when CMY toners are recorded in equal quantities onto a printing medium, substantially achromatic color is produced.

In this embodiment, since Fₙ(k) generally increases gradually together with gradual increase of tone value k, substitution level will be higher the greater the baseline toner usage quantity prior to correction. This is in order to suppress as much as possible the effects of substitution on graininess, hue, and saturation. That is, where K tone value is small the recording level of K will be small, and where K is considered in isolation, will be light black. Typically, when it is attempted to represent achromatic color with CMY toner, there is a slight color tinge, and this tendency is stronger for lighter colors.

Additionally, since recording materials are recorded on a dot-by-dot basis during printing by the printer, in some instances recording material are perceived as tiny dots on the printing medium (graininess), with such graininess being more noticeable where K toner tone value is smaller (toner recording rate is lower). Given this, substitution is held to the lowest possible level for small tone values, with substitution level being increased in association with larger tone values k. By designating the upper limits of substitution level as Kₘₐₓ₁ and Kmₘₐₓ₂, excessive substitution may be avoided. As a result, the effects of substitution on graininess, hue, and saturation may be suppressed to the maximum extent possible.

In this embodiment, substitution level for text is slightly lower than for non-text images. Accordingly, in this embodiment, even if substitution has been carried out, text will not have a more grainy appearance as compared to non-text images, and printing takes place with hue and saturation conditions approximating the baseline color specified by the print data 11. Additionally, where text and non-text images are compared, whereas in the case of text it is almost certain that there will be areas of the printing medium devoid of recording material recorded thereon so that the surface is exposed, whereas in the case of non-text, there are instances in which substantially none of the printing medium surface is exposed, with recording material usage quantities tending to be higher in general.

Accordingly, by substituting at higher levels for non-text images than for text, the time until the recording material is used up can be effectively extended. When correction is carried out at substitution levels determined in advance for each attribute by means of the above process, the color correction module 27c determines whether the color correction process has been completed for all pixels of the aforementioned raster data (Step S155). The process beginning with Step S140 is repeated until it is determined that the process has been completed for all pixels.

When on the other hand it is determined in Step S130 that the K toner value is not below the threshold value α, a determination is made as to whether remaining quantity of any of the CMY toners is below the threshold value α (Step S160). When it is determined in Step S160 that none of the remaining quantities of the CMY toners are below the threshold value α, since there are extra remaining quantities of K toner and CMY toner, the correction process is skipped. When it is determined in Step S160 that the remaining quantity of any of the CMY toners is below the threshold value α, since the condition is one of extra remaining quantity of K toner and no extra remaining quantity of any of the CMY toners, a process is carried out to substitute K toner for CMY toner.

In this instance as well, in order to establish different substitution levels for different image attributes, the color correction module 27c discerns the aspect of an image on the basis of the aforementioned identifying data (Step S165). When in Step S165 it is discerned that the attribute of an image is text, it performs text correction (correction process 3) (Step S170), or when it is discerned that the attribute of an image is non-text, it performs non-text correction (correction process 4) (Step S175).

In FIG. 5 is shown a graph of specific examples of correction data in correction processes 3, 4. The horizontal axis indicates any of the tone value cmy of the CMY components in the raster data prior to correction, and the vertical axis indicates correction level Fₙ(cmy). (cmy) indicates tone value of the toner having the smallest remaining quantity of the CMY toners. n is a natural number, with n=3 indicating the correction level of correction process 3 and n=4 indicating the correction level of correction process 4. For correction levels 3 and 4, where tone values of the CMY components are designated respectively as cmy, and corrected CMYK tone values are designated respectively as c′, m′, y′, and k′, corrected tone values are given by the following equations.
c′=c−Fₙ(cmy)
m′=m−Fₙ(cmy)
y′=y−Fₙ(cmy)
k′=k+Fₙ(cmy)

Here as well, by varying the form of the functions F₃(cmy) and F₄(cmy) as shown in FIG. 5, different substitution levels are produced in correction processes 3 and 4. Specifically, where substitution level is determined on the basis of tone value of the toner having the smallest remaining quantity of the CMY toners, and tone value of this color increases gradually, Fₙ(cmy) increases gradually once tone value exceeds a predetermined value (CMYₛ₃, CMYₛ₄), and once tone value exceeds a certain value, Fₙ(cmy) maintains a constant value (CMYₘₐₓ₃, CMYₘₐₓ₄).

In FIG. 5 as well, the substitution level F₃(cmy) of correction process 3 is such that it does not exceed the substitution level F₄(cmy) of correction process 4. Accordingly, the substitution level will be lower for text images than for non-text images. Here, correction is carried out my means of incrementing or decrementing the original tone value cmyk by substitution level Fₙ(cmy), with substitution level Fₙ(cmy) being added to the k toner and substitution level Fₙ(cmy) being subtracted from the cmy toners. Accordingly, substitution is carried at a 1-to-1 ratio of K toner quantity to CMY toner quantity.

As a result, there are afforded advantages similar to correction processes 1, 2 described previously, and color deviation of text is less likely to occur as compared to non-text images, despite carrying out substitution. Additionally, the time until recording material runs out can be effectively extended. Once correction is carried out with substitution levels determined on an attribute-by-attribute basis by means of the above processes, the color correction module 27c determines whether the color correction process has been completed for all pixels of the aforementioned raster data (Step S180). The process beginning with Step S165 is repeated until it is determined that the process has been completed for all pixels.

The halftone process module 27d performs halftone processing on processed raster data from correction processes 1-4 or raster data converted by the color conversion module 27b (Step S185), and the print engine control module 27e controls the print engine 26 so as to record toner on each pixel on the basis of the halftone data (Step S190). As a result, when any of the CMYK toners falls below a predetermined threshold value α, substitution is carried out in such a way as to extend as much as possible the time until the toner runs out. Additionally, substitution can be carried out at favorable substitution level for each image attribute, so as to maintain as high picture quality as possible.

(4) Other Embodiments:

The embodiments described hereinabove are merely exemplary, it being possible to employ various other arrangements, provided that usage quantities of recording materials can be corrected at different substitution levels for different attributes. For example, besides an arrangement wherein the process of determining substitution level on an attribute-by-attribute basis utilizing correction data as described previously, there could instead be employed an arrangement wherein LUTs that take substitution into consideration are created in advance, and by discerning the attribute of an image and selecting the appropriate LUT when carrying out color conversion, raster data that takes correction into consideration is created. Since such an arrangement could be realized by the color conversion module 27b by means of a process substantially identical to the process of the color correction module 27c, the arrangement can be made simpler, and the process can proceed faster.

Also, whereas in the embodiments hereinabove, correction was carried out such that substitution levels differ on an attribute-by-attribute basis, substitution levels may be varied taking into consideration other parameters as well. For example, there could be employed an arrangement wherein in order to carry out color matching with high accuracy for a particular color, such for as a company logo mark or the like, it is instructed whether to take such a particular color into consideration. Then, when it is instructed to take the particular color in question into consideration, it is possible to employ an arrangement such as not carrying out substitution for the particular color, or minimizing the substitution level. By means of such an arrangement, color matching can be carried out with high accuracy for a particular color, and for toner other than that of the particular color, the time until the toner runs out can be extended.

Of course, in the embodiments hereinabove, in order to suppress the effects of substitution on color, this is achievable by adjusting the aforementioned parameters (Kₛ₁, Kₛ₂, Kₘₐₓ₁, Kₘₐₓ₂, CMYₛ₃, CMYₛ₄, CMYₘₐₓ₃, CMYₘₐₓ₄) in addition to minimizing substitution levels.

That is, the larger the lowest tone values (Kₛ₁, Kₛ₂, CMYₛ₃, CMYₛ₄) for carrying out substitution are, the more substitution for light color is suppressed, so that the occurrence of graininess and deviation in hue or saturation can be suppressed. Where the maximum substitution levels (Kₘₐₓ₁, Kₘₐₓ₂, CMYₘₐₓ₃, CMYₘₐₓ₄) are smaller, excessive substitution can be suppressed, and the occurrence of graininess and deviation in hue or saturation can be suppressed. Accordingly, variation in color for a particular color can be suppressed by means of these parameters.

Additionally, whereas in the embodiments hereinabove, substitution was carried out associating 1 part of CMY toner with 1 part of K toner, this ratio is not mandatory. That is, in order to carry out substitution so as to reduce the effects on color and graininess to the greatest extent possible, the ratio of 1 part of CMY toner to 1 part of K toner can be varied, or different ratios used for the individual colors CMY.

Further whereas in the embodiments hereinabove, toner ink remaining quantities were discerned with a threshold value α for all colors, it would of course be acceptable to have a different threshold value for each color. By means of such an arrangement, by setting larger threshold values for colors that are used up at a relatively fast rate, the time until toner runs out can be extended more efficiently. Of course, various arrangements are possible, e.g. threshold values could be determined in advance, or an arrangement wherein they are determined on the basis of user input would be acceptable.

In the embodiments hereinabove, printing is carried out by the printer 20 using CMYK toner, but of course the number of colors and the color components are not limited to these. For example, the invention is applicable also to printers that, rather than the four colors CMYK, use instead recording materials of the six colors CMYKlclm (lc: light cyan, lm: light magenta), or of the seven colors CMYKlclmDY (DY: dark yellow) or CMYKRGB (G: green, B: blue).

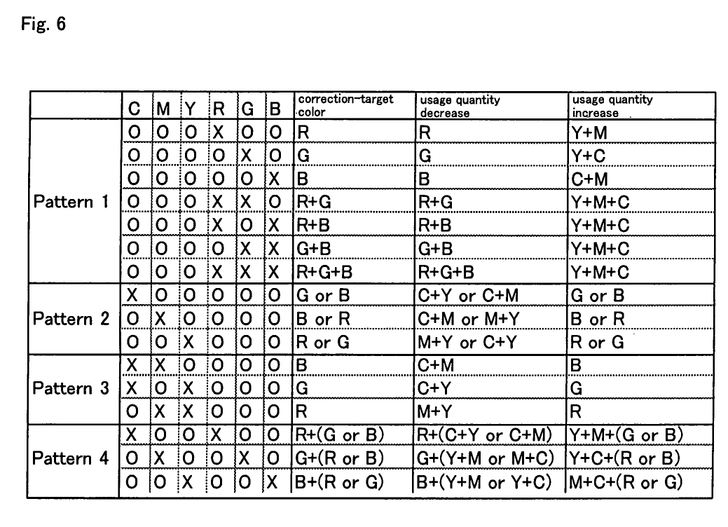

FIG. 6 is a diagram showing an example of carrying out substitution with a printer that uses CMYKRGB toners. In the drawing, circles in the CMYRGB columns indicate extra remaining quantity, while X's represent that remaining quantity has fallen below a predetermined level. It is possible to reproduce an extremely large number of colors with combinations of CMY toners and combinations of RGB toners, and virtually any color can be created using combinations of particular colors.

Given this, by selecting any color as a color targeted for correction, and increasing or decreasing the usage quantity of toner representing approximately the same color as the color targeted for correction or of a toner combination representing approximately the same color as the color targeted for correction, toner substitution can be carried out for chromatic colors. For example, in Pattern 1 shown in the drawing, when toner of a certain one or more colors falls below a predetermined threshold value, the color represented by the toner of a one or more colors is designated as the color targeted for correction, and usage quantity of the toner of a one or more colors is decreased. Thus, the decreased toner is substituted with toners of two or more other colors.

For example, when the remaining quantity of R toner falls below a predetermined threshold value, R is designated as the color targeted for correction, and Y and M toners, which when combined can produce color approximately the same as R, are increased. The substitution ratio at this time can be determined based on various conceptual approaches; like the graphs shown in FIG. 4 or FIG. 5 described previously, substitution levels can be defined with respect to uncorrected tone values, and tone values corrected by means of incrementing or decrementing with respect to uncorrected tone values. Of course, at this time, different substitution levels are specified for different image attributes, to carry out favorable correction on an attribute-by-attribute basis so as to avoid as much as possible effects on picture quality.

Pattern 1 shown in FIG. 6 shows another example of correction based on a similar conceptual approach. For example, when remaining quantities of R and G toner have fallen below predetermined threshold values, colors reproducible by combinations of R and G are designated as colors targeted for correction, usage quantities of R and G toner are reduced, and Y, M, and C toners, which when combined can produce colors approximately the same as combinations of R and G, are increased. The case where remaining quantities of R and B toner have fallen below predetermined threshold values, and the case where remaining quantities of G and B toner have fallen below predetermined threshold values, can be thought of analogously, increasing and decreasing toners of the colors indicated in FIG. 6. When increasing and decreasing toners of the colors indicated in FIG. 6, colors reproducible by combinations of R, G, and B are designated as colors targeted for correction, usage quantities of R, G, and B toner are reduced, and Y, M, and C toners, which when combined can produce colors approximately the same as combinations of R, G, and B, are increased.

It is also acceptable for color targeted for correction and color whose usage quantity is decreased to differ from one another. For example, in the manner of Pattern 2 shown in FIG. 6, when the remaining quantity of C toner has fallen below a predetermined threshold value, colors representable by either G or B or combinations thereof are designated as colors targeted for correction, and usage quantities of C and Y or C and M are decreased. Of course, the case where the remaining quantity of M toner has fallen below a predetermined threshold value, or the case where the remaining quantity of Y toner has fallen below a predetermined threshold value, can be thought of analogously, increasing and decreasing toners of the colors indicated in FIG. 6. The case that, in the manner of Pattern 3, remaining quantities of C and M toner have fallen below predetermined threshold values, the case where the remaining quantities of C and Y toner have fallen below predetermined threshold values, and the case where the remaining quantities of M and Y toner have fallen below predetermined threshold values can be thought of analogously, increasing and decreasing toners of the colors indicated in FIG. 6.

Of course, substitution can also be carried out in instances where two or more colors of either the CMY system or the RGB system have fallen below predetermined threshold values. For example, when remaining quantities of C and R toner have fallen below predetermined threshold values as in Pattern 4, colors representable by combinations of R and G or R and B are designated as colors targeted for correction, toner usage quantities in combinations of R, C, and Y or R, C, and M are decreased, and toner is increased in combinations of Y, M, and C or Y, M, and B. Of course, the case where the remaining quantities of M and G toner have fallen below predetermined threshold values, or the case where the remaining quantities of Y and B toner have fallen below predetermined threshold values can be thought of analogously, increasing and decreasing toners of the colors indicated in FIG. 6.

Here, substitution has been described with reference to chromatic colors, by substitution between CMY and K in the same manner as in the preceding embodiments is possible for achromatic colors as well, as is substitution between RGB and K or CMY and RGB. It is also possible to carry out substitution by means of dark and light recording materials as described previously. In this way, the invention is broadly applicable to printers equipped with interchangeable recording materials.

Of course, various classifications of image attributes are possible besides classification into the two types of text and non-text. For example, classification according to the attribute of a bitmap image versus that of a vector image is acceptable, as is classification according to the attribute of a photographic image versus other types of images (e.g. an image such a graph). By means of such arrangements, favorable correction levels can be designated for attributes desired by the user. Further, the present invention is not limited to an arrangement whereby correction is performed with a processes by the printer; arrangements wherein the color conversion process or correction process is executed by the computer 10 are acceptable as well. The printer format is not limited to a laser printer, the invention being applicable to various printer formats such as ink-jet printers.

1. Printing control device for controlling a printing device that executes printing utilizing a plurality of recording materials in a relationship whereby output color of a particular recording material is substitutable by output color of another recording material,
said printing control device comprising:
a print data acquiring portion that acquires print data indicating an image targeted for printing;
a usage quantity determining portion that determines usage quantity of each recording material on the basis of said print data;
a recording material remaining quantity detecting portion that detects whether the remaining quantity of said particular recording material is less than a predetermined baseline;
an attribute detecting portion that detects the attribute of said image on the basis of said print data;
a usage quantity correcting portion that, when detected that the remaining quantity of a particular recording material is less than a predetermined baseline, substitutes a portion of said particular recording material with said other recording material so that substitution level differs for each attribute of images targeted for printing, and corrects said determined usage quantity; and
a printing execution portion that executes printing at the usage quantities derived thereby.

2. Printing control device according to claim 1 wherein said print data is data described in page-description language, and said attribute detecting portion detects image attributes on the basis of said page-description language.

3. Printing control device according to claim 1 wherein said attribute detecting portion associates attribute data indicating the attribute of a detected image with the detected image, and said usage quantity correcting portion carries out the recording material substitution process in accordance with a substitution rule associated with said attribute data.

4. Printing control device according to claim 1 wherein said attribute detecting portion detects at a minimum text and non-text images as different attributes.

5. Printing control device according to claim 4 wherein said usage quantity correcting portion performs substitution level in a relationship 0≦X<Y, where X denotes the substitution level of said particular recording material where the attribute is text, and Y denotes the substitution level of said particular recording material where the attribute is non-text.

6. Printing control device according to claim 1 wherein said usage quantity correcting portion corrects usage quantity with different substitution levels depending on color output accuracy.

7. Printing control device according to claim 1 wherein said usage quantity correcting portion corrects usage quantity with different substitution levels depending on usage quantity of recording material determined by said usage quantity determining portion.

8. Printing control device for controlling a printing device that executes printing utilizing a plurality of recording materials in a relationship whereby output color of a particular recording material is substitutable by output color of another recording material,
said printing control device characterized in that when the remaining quantity of said particular recording material is less than the remaining quantity of said other recording material, a portion of the baseline usage quantity in said particular recording material is substituted with said other recording material, and printing is executed while determining usage quantities of recording materials so that substitution levels in said substitution are a different substitution level for each attribute of the image targeted for printing.

9. Printing control method for controlling a printing device that executes printing utilizing a plurality of recording materials in a relationship whereby output color of a particular recording material is substitutable by output color of another recording material,
said printing control method comprising the steps of:
acquiring print data that indicates an image targeted for printing;
determining usage quantity of each recording material on the basis of said print data;
detecting whether the remaining quantity of said particular recording material is less than a predetermined baseline;
detecting the attribute of said image on the basis of said print data;
when detected that the remaining quantity of a particular recording material is less than a predetermined baseline, substituting a portion of said particular recording material with said other recording material so that substitution level differs for each attribute of images targeted for printing, and corrects said determined usage quantity; and
executing printing at the usage quantities derived thereby.

10. Printing control method for controlling a printing device that executes printing utilizing a plurality of recording materials in a relationship whereby output color of a particular recording material is substitutable by output color of another recording material,
said printing control method characterized in that when the remaining quantity of said particular recording material is less than the remaining quantity of said other recording material, a portion of the baseline usage quantity in said particular recording material is substituted with said other recording material, and printing is executed while determining usage quantities of recording materials so that substitution levels in said substitution are a different substitution level for each attribute of the image targeted for printing.

11. Printing control program product for controlling a printing device that executes printing utilizing a plurality of recording materials in a relationship whereby output color of a particular recording material is substitutable by output color of another recording material,
said printing control program product comprising the following program code:
print data acquisition program code for acquiring print data that indicates an image targeted for printing;
usage quantity determination program code for determining usage quantity of each recording material on the basis of said print data;
recording material remaining quantity detection program code for detecting whether the remaining quantity of said particular recording material is less than a predetermined baseline;
attribute detection program code for detecting the attribute of said image on the basis of said print data;
usage quantity correction code for, when detected that the remaining quantity of a particular recording material is less than a predetermined baseline, substituting a portion of said particular recording material with said other recording material so that substitution level differs for each attribute of images targeted for printing, and corrects said determined usage quantity; and
printing execution program code for executing printing at the usage quantities derived thereby.

12. Printing control program product for controlling a printing device that executes printing utilizing a plurality of recording materials in a relationship whereby output color of a particular recording material is substitutable by output color of another recording material,
said printing control program product comprising the following program code:
printing execution program code for, when the remaining quantity of said particular recording material is less than the remaining quantity of said other recording material, substituting a portion of the baseline usage quantity in said particular recording material is with said other recording material, and executing printing while determining usage quantities of recording materials so that substitution levels in said substitution are a different substitution level for each attribute of the image targeted for printing.
